(19) United States
(12) Patent Application Publication
(10) Pub. No.: US 2025/0065792 A1
(43) Pub. Date: Feb. 27, 2025

(54) VERSATILE CONFIGURABLE ROBOT/VEHICLE CARRIER FOR ROBOT/VEHICLE DOCKING, CHARGING, TRANSPORTING, AND CONTROL

(71) Applicant: Edmund Shen, Fremont, CA (US)

(72) Inventor: Edmund Shen, Fremont, CA (US)

(21) Appl. No.: 18/761,217

(22) Filed: Jul. 1, 2024

Related U.S. Application Data
(60) Provisional application No. 63/511,682, filed on Jul. 2, 2023.

(51) Int. Cl. B60P 3/073; B60J 7/185; B60L 50/60; B60L 53/12; B60L 53/14; B60P 1/43; B60W 60/00; B62D 63/02

(52) U.S. Cl. CPC B60P 3/073; B60L 50/60; B60L 53/12; B60L 53/14; B62D 63/025; B60J 7/185; B60P 1/43; B60W 60/00

(57) ABSTRACT

The invention, Versatile Configurable Robot/Vehicle Carrier, also known as “Robotruck™”, is a versatile AI-powered Electric or Hybrid Carrier Vehicle designed for autonomous robots, drones, sub-vehicles, forklifts, and other mobility equipment. Functioning similarly to an aircraft carrier, this hosting vehicle integrates advanced battery technology, Software-Defined Vehicle (SDV) and Connected Vehicle technologies to facilitate the transport, docking, on-board charging (wireless or cabled), reloading, guiding, managing, commanding and communication to various robots and autonomous sub-vehicles. It supports applications such as last-mile delivery, local dispatch, on-site robot services, and patrols. The Carrier, Robotruck™, features a configurable vehicle platform with an innovative body structure suitable for off-road and on-road use, a modular E-Powertrain skateboard, and advanced AI-driven control functions with telematics, IoT connectivity, In-Vehicle Infotainment (IVI) System, and GPS tracking, offering customizable modules for different carrying functions, sizes, driving ranges, and power capacities.

The present application claims priority to the earlier filed provisional application having Ser. No. 63/511,682, on Jul. 2, 2023, with the same title, and hereby incorporates subject matter of the provisional application in its entirety.

### BACKGROUND OF THE INVENTION

The delivery business is increasing rapidly these years when internet business and e-commerce expanding. But most of these deliveries are utilizing the traditional way with trucks or vans, but they are costly with labors, fuels/energy, and time.

Robots, autonomous vehicles, and drones for delivering or transporting materials indoor/outdoor have been developing and utilizing in many applications nowadays, such as autonomous package or food delivery vehicles and robots. Delivery robots offer a number of advantages:
1. Improved efficiency: The delivery robots can operate around the clock and make deliveries more quickly and reliably than human drivers, reducing wait times and improving the overall customer experience.
2. Cost savings: Using delivery robots can be more cost-effective than paying human delivery drivers, especially for businesses that make a high volume of deliveries.
3. Reduced contact: With delivery robots, customers can receive their order without having to come into contact with delivery drivers, reducing the risk of spreading virus and increasing safety.
4. Increased safety: Robots are equipped with sensors and other safety features that allow them to navigate around obstacles and avoid collisions, reducing the risk of accidents and injuries.
5. Sustainability: Robots are capital equipment, and they can be used continuously with routing maintenance and upgrading.
6. Accuracy: Robots can increase the accuracy of delivery by sending message or making phone call automatically, or showing customer on the APP map how far and how soon to the customer the exact time of delivery and receive the confirmation.

But these Robots have following disadvantages and limitations:
1. Limited Range
2. Low Speed
3. Limited Storage
4. Safety: They could be easily disabled, damaged because of road condition, technical issue or battery outage, or stolen due to their small sizes.
5. Inefficient fleet management
6. Limited communication with central station

The current ways to solve above issues in many applications are either:
A) build many local satellite stations and charge facilities.
B) Using regular trucks, vans, car-carrying trailer, vehicle hauler, or auto transport trailer, to transport above robot or sub-vehicles, but they have following disadvantages:

The A way has following limitations:
1. It is very expensive and slow to expand.
2. It's may applicable in metropolitan area, but it's not economical for the costs in suburban or countryside.
3. It is difficult to provide instant support for the robots or vehicles in the field.

For the B way, there are following limitations:
1. They cannot be charged on vehicles. The carrying vehicle must bring them to the charge ports to charge.
2. There is a lot of manual work and time consuming to bring them to nearest station to reload goods.
3. There is no communication way originally installed on the carrying vehicle. The robots or sub-vehicles cannot locate the Carrying Vehicle by themself, especially when the Carrying Vehicle moves from the original position.
4. It is difficult to provide support either by central office or carrying vehicles when robots or sub-vehicles has customer issues, or they are damaged or stolen when they are in service.

Unlike the traditional vehicles, a Versatile Configurable Robot/Vehicle Carrier, herein called “Carrier”, is not just a wheeled cabinet used transporting robots, drone or sub-vehicles. It is a configurable central hosting hub and docking station similar to an Aircraft Carrier, but it mainly for robots, drones, and autonomous sub-vehicles, herein called “Robots”, which is a highway capable Electric or Hybrid Vehicle with advanced battery/energy storage technology, wireless charging, SDV and Connected Vehicle technologies. The Carrier Invention innovatively solve all above issues.

### SUMMARY

The present invention describes a technology of a Versatile Configurable Robot/Vehicle Carrier, as known as “Robotruck™”, trademark filed as U.S. application No. 63/511,682 on Apr. 23, 2023 with USPTO International Application Reference #A0138158, and International Bureau of WIPO application #1723721 on Aug. 9, 2023, and herein called “Carrier”, which is a hosting Electric or Hybrid Vehicle with Software-Defined Vehicle (SDV) and Connected Vehicle technologies for carrying, transporting, docking, charging (wireless or cabled), reloading, guiding, managing, and commanding autonomous or self-movable Robots, Drones, or Vehicles, namely, robots, drones, sub-vehicles, forklifts, and other mobility equipment for different purposes, such as the last-mile delivery, local dispatching, on-site robot services, and robot patrols. Similar to an aircraft carrier, the Carrier is an AI powered intelligent docking station that can guild, command or communicate the robots or sub-vehicles to move on and off the Carrier by themselves for automated or autonomous delivery, charging, dispatching, reloading, or other applications. The Carrier's advanced energy storage system is safe, durable, and big enough to supply battery power for both the carrier itself and Robots/Sub-Vehicles on-board charging;

The Carrier is also a configurable vehicle platform for carrying different Robots/Sub-Vehicles, or other purposes with different sizes, functions, and applications. The Carrier design consist with an innovative configurable vehicle body structure for both off-road and on-road applications, a configurable E-Powertrain skateboard, and a configurable AI intelligent SDV driving and control system leveraging advanced technologies such as telematics, IoT connectivity, GPS tracking, and more, which can be easily replaced, modified, or upgraded with different designated modules to have different functions, drive range, and house power. The configurable AI SDV system can manage vehicle operations, fleet management, adding functionality, and enable new features primarily or entirely through software and internet. The The Carrier Vehicle can be driven either by human driver or autonomously. The Robots and Sub-Vehicles on the Carrier Vehicle are normally driven autonomously.

The Carrier vehicle is new type of electric/hybrid vehicle as a Robot/Vehicle Carrier and a Software-Defined Vehicle as the next evolution with smart docking, wireless or cable on-deck charging, loading, and “Connected Vehicle” internet-capable control functions with In-Vehicle Infotainment (IVI) System. This invention is to solve the limitation issues of robots and small sub-vehicles, such as range, speed, control, and security, for increasing demands on local delivery or onsite-services, and to solve the limitation of current normal vehicles on the market with a versatile mobility platform as a Customizable Carrier vehicle with many different features, apps, and functions. Vehicles and fleets are optimizing operations and enhancing safety through 5G or higher networking solutions. The reliable in-vehicle connectivity empowers businesses to elevate customer service with features like guest Wi-Fi and digital signage.

### BRIEF DESCRIPTION OF THE DRAWINGS

A brief description of the Figures is as follows:

FIG. 1 is a front perspective view of the Carrier vehicle with Hawk Wing Door open. The angels of the hawk wing doors are adjustable by user.

FIG. 2 is a front elevation view of the Carrier.

FIG. 3 is a front elevation view of the Carrier with Hawk Wing Door open in low angle.

FIG. 4 is a top side view of the single cab Carrier with one row of seat, and the both sides of bed skirt panels are open. The Carrier can be configured as either single-cab or double-cab.

FIG. 5 is a rear elevation view of the Carrier.

FIG. 6 is a left-side elevation view of the Carrier with door open.

FIG. 7 is a right-side elevation view of the Carrier.

FIG. 8 is a rear perspective view of the Carrier.

FIG. 9 is a top view of the Carrier with door open. The roof can be either a metal roof or a Glass Panoramic Rooftop. The wireless charging system is located underneath of the truck bed.

FIG. 10 is a top view of the Carrier with interior view and wireless charging on the bed floor.

FIG. 11 is a top view of the Carrier's hub bed area with side-foldable docking bed cover at closed position. The side-foldable docking bed cover is installed on the bed wall skirt, either power open-close or manual open-close. The cover material can be either steel, glass, or other materials.

FIG. 12 is a top view of the Carrier's hub bed area with side-foldable docking bed cover at its opening position. The cover is folded at the inside of the bed wall, and there is a secure cover on both sides to secure the bed cover with water proof design.

FIG. 13 is an inside view of the Carrier bed area with interior docking structure, and side-foldable docking bed cover at opening position. The wireless charging system or the cable charging system is located underneath of the truck bed.

FIG. 14 is an inside view of the Carrier “hub” storage area with interior charging ports, locking structure, and a view of the open-foldable mid-gate. The wireless charging system or the cable charging system is located underneath of the truck bed.

FIG. 15 is a view of the how delivery robots docking on the Carrier docking bed, and how Carrier dispatches 6 delivery robots to the city street for delivery tasks.

FIG. 16 is a view of the Carrier dispatches 2 drones on the off-road field for exploring or delivery tasks. The drone docking station can be configured in the bed of vehicle and the top of vehicle.

FIG. 17 is a view of a drone docking on the docking floor for Wireless Charging.

FIG. 18 is a diagram for Wireless Charging.

FIG. 19 is showing the 6 different seat arrangements of a Carrier.

FIG. 20 is a side view drawing of a Carrier.

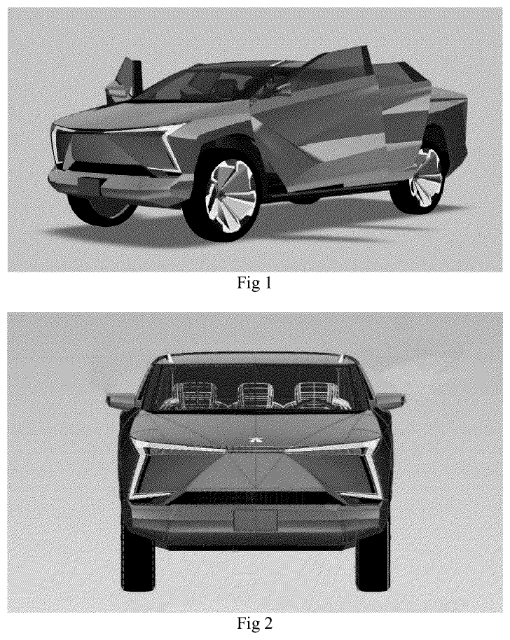

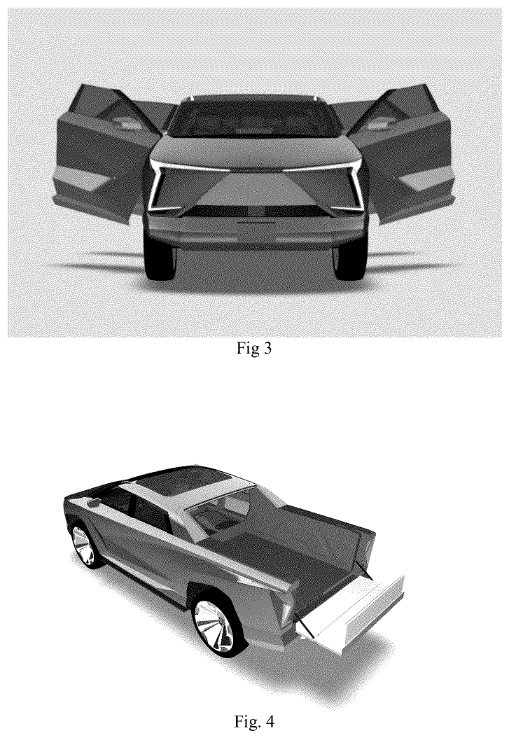

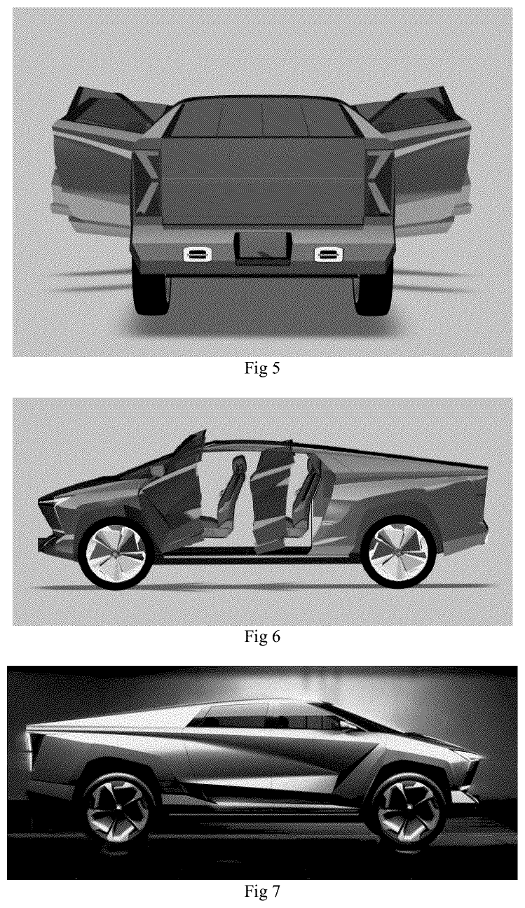

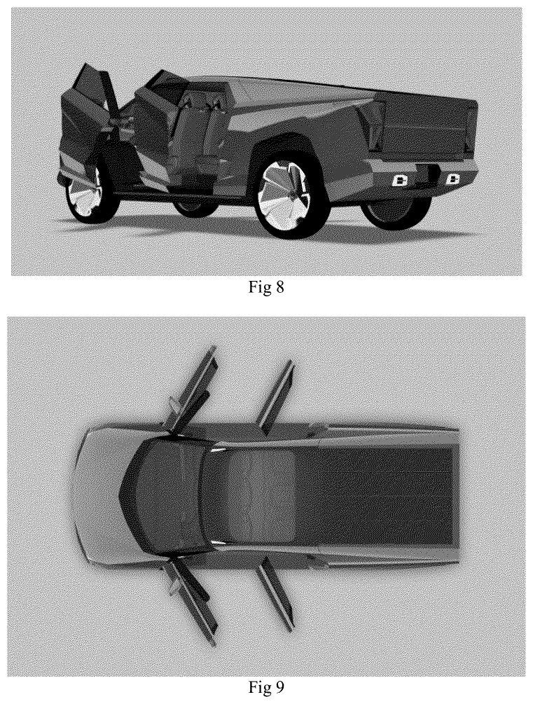

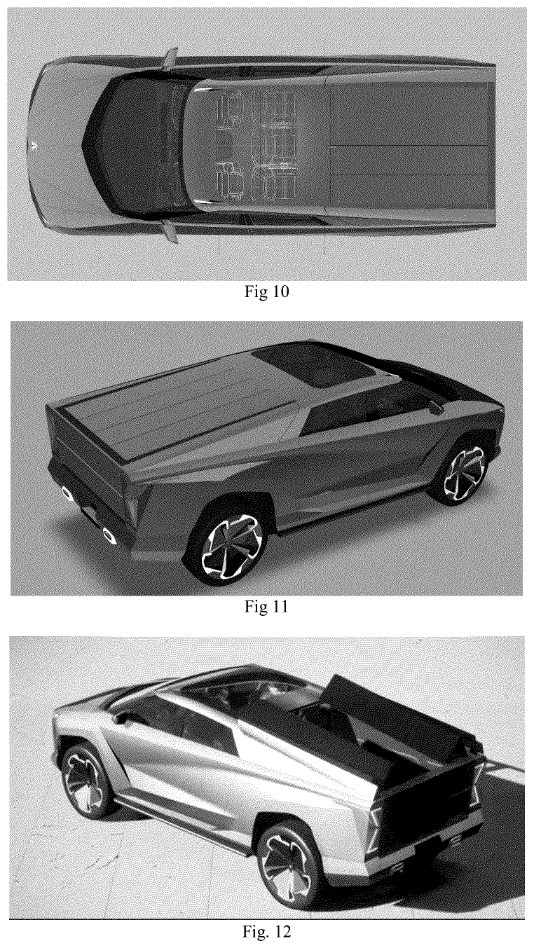

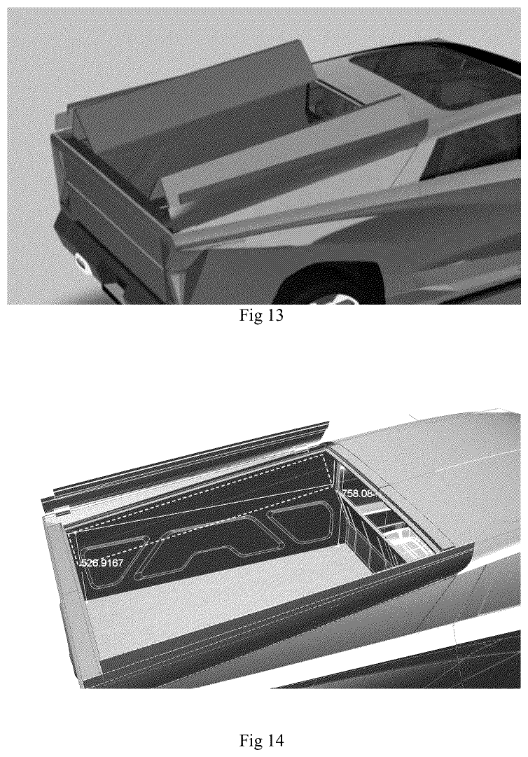

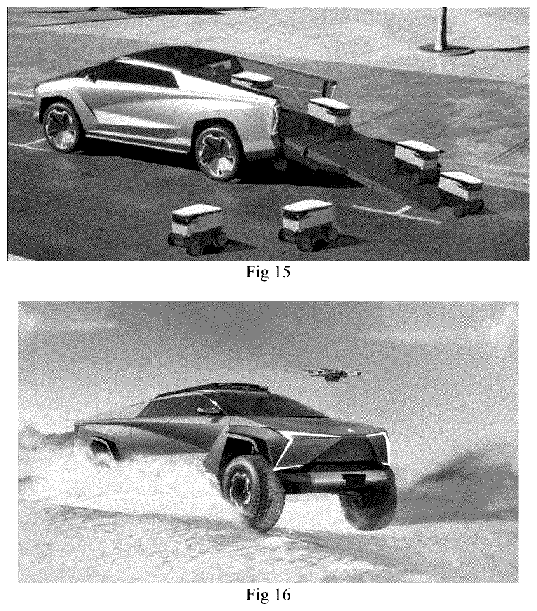

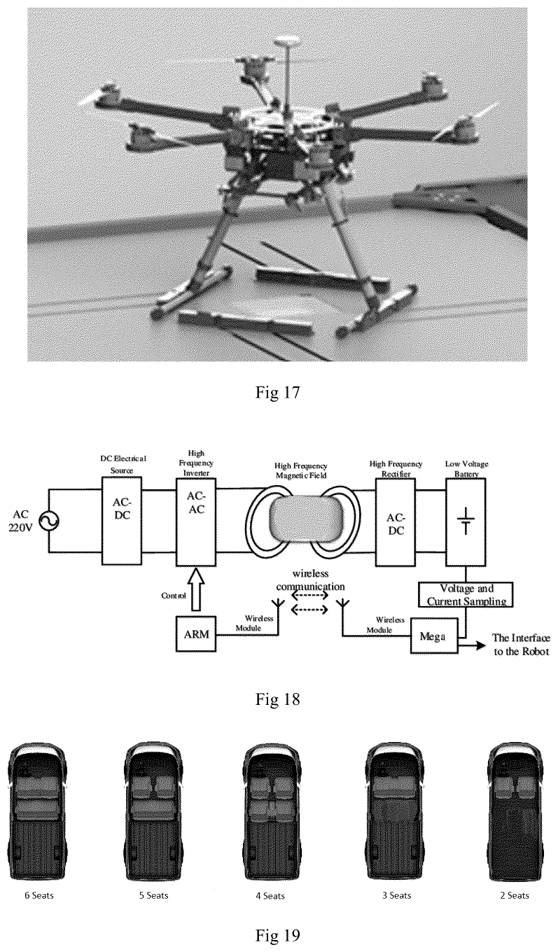

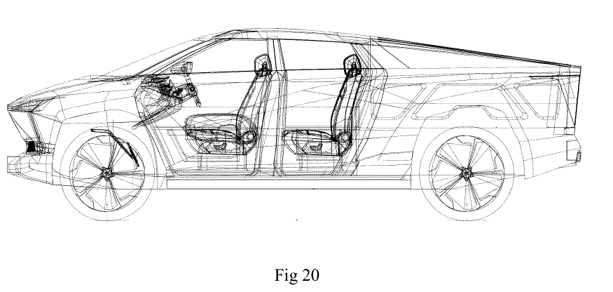

### DETAILED DESCRIPTIONS

### The Carrier Vehicle Definition:

The Carrier is new type of vehicle, also known as “Robotruck™”, is a versatile AI-powered carrier designed for autonomous robots, drones, sub-vehicles, forklifts, and other mobility equipment. Functioning similarly to an aircraft carrier, this hosting vehicle integrates Software-Defined Vehicle (SDV) and Connected Vehicle technologies to facilitate the transport, docking, charging (wireless or cabled), reloading, guiding, managing, and communication to various robots and autonomous sub-vehicles. It supports applications such as last-mile delivery, local dispatch, on-site robot services, and patrols. The Carrier, Robotruck™, features a configurable vehicle platform with an innovative body structure suitable for off-road and on-road use, offering customizable modules for different carrying functions, sizes, driving ranges, and power capacities. The Carrier Vehicle can be driven either by human driver or autonomously. The Robots and Sub-Vehicles on the Carrier Vehicle are normally driven autonomously.

### Invention Technical Descriptions:

The Carrier Invention consists with following features:
1. The Carrier's On-Vehicle Wireless or Cabled DC and AC Charging System for Robot and Sub-Vehicles:
   1) The wireless or Cabled charging system is located underneath of the truck bed or cargo floor at the back of vehicle.
   2) The on-vehicle Wireless Charging is the main method for Carrier's robot, drone, and sub-vehicle on board charging, which is very flexible for on vehicle charging. The wireless charging system can use any power source, including AC or DC, to generate a wireless power signal. The signal is then converted to DC by the onboard charger, which can be programmed to follow specific charge cycles for different battery types. Because wireless charging is slow, the cabled charging method is still available for customer's request.
   3) The Vehicle DC charging ports designed as a horizontally lined structure, which can be easily configured to multiple charging ports with 480 DC or higher for fast-charging.
   4) The Vehicle AC charging ports designed as a horizontally lined rail-like structure, which can be easily to configured with multiple charging ports with 110V AC for slow-charging in certain as-needed cases.
   5) The DC and AC charging ports have sensors and a self-locking device to let robots or sub-vehicles to locate the charge ports and to lock their position for charging.
   6) All the electrical power is taken from Carrier's vehicle battery power system. The invention has a pre-made modular configurable power cable and wire harness assembly system to make customized power charge system easy to be configured like a LEGO.
   7) The Carrier battery pack utilize configurable battery sizes with Solid-State, LFP, or NCM/NCA battery technologies, which is user's choice to support the Carrier's driving range and Sub-Vehicles charging application. The Carrier's advanced energy storage system is safe, durable, and big enough to supply battery power for both the carrier itself and Robots/Sub-Vehicles on-board charging;
2. On-Floor Self-Locking Structure for Sub-Vehicles:
   The Carrier invention relates to a working vehicle including rail-structured self-locking devices with tying-down points for preventing robot or sub-vehicle movement at the time of transportation or parking.
3. The Robot/Sub-Vehicle Hub/Docking Station
   1) The robot/sub-vehicle hub is located at the vehicle truck bed or cargo area or on the top of vehicle roof, or both areas with a cover or enclosure to enclose the robots for protection based on actual application. It's more applicable for Drones to have the docking station on the top of vehicle roof.
   2) The modularized Carrier design can be easily configured for different charging ports, sizes, docking methods to different robots, drones, and sub-vehicles.
4. Special AI powered Central Control System with Telematics, SDV and Connected Vehicle technologies for both Carrier's AI Autonomous Driving and Robot Fleet Management:
   1) Carrier has a control system with sensors, cameras, database, communication, instant GPS Map tracking, and AI software apps, which is easy to be installed on both Carrier Vehicle and Sub-Vehicles for communication.
   2) The Carrier and Robots communication App can communicate to the customer by sending message, making phone call, or showing customer on the APP map how far and how soon the delivery is coming, which increased delivery accuracy with delivery confirmation automatically.
   3) The Carrier's AI-Powered Telematics system is able to monitoring both Carrier itself and the robots/sub-vehicles by using GPS technology and on-board diagnostics (OBD) to plot the vehicle movements on a computerized map.
   4) The robots, drones, or sub-vehicles can easily locate the Carrying Vehicle with GPS, and signal devices by themselves in any locations, even when the Carrying Vehicle moves from its original position.
5. Automated Ramp, Lift, and Docking Entry Door
   1) The Carrier has an automated ramp or lift, along with automated tailgate or back door, which allows robots, or sub-vehicles to move up or down to the Carrier's floor autonomously.
   2) The Carrier has an automated docking entry door on roof area, which allows drones to dock on the Carrier's docking area autonomously.
6. Automated Side-Open/Close Docking Bed Cover
   1) It can be Open or Close from the both sides of the Docking Bed wall to protect the robots inside. When it open, the two pieces of the cover panels will be folded into the back fender tops, the bed skirts, on both sides.
7. Versatile Configurable Vehicle Structure
   1) The Carrier design consist with an innovative configurable Vehicle Body Structure. The Carrier can be configured as either single-cab or double-cab per user's needs.
   2) The strong, durable and reliable modular body structure made the Carrier can be used on Off-Road condition as well for Off-Road applications.
   3) Besides of its Carrier function, it can also be easily configured for multi-versatile functions like the traditional vehicle types such as, Pickup Truck, SUV, Crossover, Mini Van, Light Cargo Van, and other type of Utility Vehicles, etc., which gives user flexibility for different usages or off-duty needs.
   4) The Carrier can be configured as either single-cab or double-cab. The seat arrangement can be either single row for 1 to 3 passenger or two rows for 4 to 6 passengers. See FIG. 4 and FIG. 19.
   5) A configurable E-Powertrain skateboard, which can be easily replaced, modified, or upgraded with different designated modules to have different functions, drive range, and horse power.
   6) A configurable AI intelligent SDV driving system, which can be easily replaced, modified, or upgraded with different Apps to have different functions.

### Application Process and Sample:

Here is a Sample of Application Process: Door-to-Door Food Order Delivery:
1. The central fleet management station received the orders for a residential area in about one square miles.
2. The fully charged Carrier carries 6 fully charged delivery robots with total 72 orders loaded at a central station and transport them to a designated area with about one square mile radius.
3. The Carrier unloads robot 1 and 2 in Zone A, and then drives to Zone B.
4. The robot 1 and 2 start the delivery jobs one by one when the Carrier is unloading the robot 3 and 4 in Zone B.
5. After the robot 2 delivered 6 orders, it has a low battery warning, and its battery level is not enough for it to complete the rest of its work, so it asks Carrier to help.
6. At that time, the Carrier has just completed the unloading robot 5 and 6 in Zone C. After it received the request from robot 2, it drives to Zone A. Because Carrier is a highway capable vehicle, it takes only a few minutes to move from Zone C to Zone A.
7. Carrier let Robot 2 move to its docking area and take a quick charge for a few minutes, which is enough for it to finish the rest of its job.
8. Carrier goes to a local charge station to re-charge itself, and notify other robots its current Zone A location on the instant API Map while it's waiting for robots.
9. Robot 1 has completed its delivery work and back to Carrier by itself and take a power charge by itself.
10. And then, the charged Robot 2 left from carrier to continue finish the rest of its delivery.
11. Carrier drive to Zone B and C to pick the rest of robots and then drive back to Zone A to pick up Robot 2.
12. Carrier drives back central station for reloading for next dispatch.

I claim:

1. A Versatile Configurable Robot/Vehicle Carrier, as known as “Robotruck™”, as shown and described as following:
The Carrier is new type of electrical or hybrid vehicle, also known as “Robotruck™”, is a versatile AI-powered carrier designed for autonomous robots, drones, sub-vehicles, forklifts, and other mobility equipment.
The Carrier Vehicle can be driven either by human driver or autonomously.
The Carrier's On-Vehicle wireless or cabled DC and AC Charging System for Robots and Sub-Vehicles;
The Carrier's advanced energy storage system is safe, durable, and enabled to supply battery power for both the carrier itself and Robots/Sub-Vehicles on-board charging;
Special AI powered Central Control System with Telematics, SDV and Connected Vehicle technologies for both Carrier's AI Autonomous Driving and AI Autonomous Robot/Sub-Vehicle Fleet Management;
Features a configurable vehicle platform with an innovative body structure suitable for off-road and on-road use, offering customizable modules for different carrying functions, sizes, driving ranges, and power capacities.
On-Floor Self-Locking Structure for Robots and Sub-Vehicles;
The Robot, Drone, and Sub-Vehicle Hub/Docking Station;
Automated Ramp, Lift, and Docking Entry Door for robot load and unload;
Automated Side-Foldable Docking Bed Cover;
